(19) United States
(12) Patent Application Publication
(10) Pub. No.: US 2009/0244421 A1
(43) Pub. Date: Oct. 1, 2009

(54) DISPLAY APPARATUS

(75) Inventors: Toshiya ISHII, Kanagawa (JP); Hiroyuki Sekine, Kanagawa (JP)

Correspondence Address: YOUNG & THOMPSON, 209 Madison Street, Suite 500, ALEXANDRIA, VA, 22314, US

(73) Assignee: NEC LCD TECHNOLOGIES, LTD., KANAGAWA (JP)

(21) Appl. No.: 12/413,848

(22) Filed: Mar. 30, 2009

(30) Foreign Application Priority Data
Apr. 1, 2008 (JP) 2008-94941

(51) Int. Cl. G02F 1/13; H01J 1/62

(52) U.S. Cl. 349/40; 313/505

(57) ABSTRACT

A display apparatus includes a plurality of internal wirings and a protective element which includes a first terminal and a second terminal at least. The first terminal is connected to at least one of the plurality of internal wirings, and the second terminal is connected to an external circuit.

### RELATED APPLICATIONS

This application is based on Japanese Patent Application No. JP 2008-94941 filed on Apr. 1, 2008, and including a specification, claims, drawings and summary. The disclosure of the above Japanese Patent Application is incorporated herein by reference in its entirety.

### TECHNICAL FIELD

The present invention relates to a display apparatus such as a liquid crystal display apparatus and an EL (electro-luminescence) display apparatus.

### BACKGROUND ART

An active matrix type display in which a TFT (thin film transistor) which is an active element is arranged for every pixel is known. For example, an active matrix type liquid crystal display (LCD) device is used as a display apparatus for various apparatus including flat TV, because it is high definition, can reduce a thickness of the device and is light in weight, and power dissipation thereof is small. The further miniaturization and higher definition of an active matrix type liquid crystal display apparatus have been achieved by a development of finer manufacturing process thereof. Therefore, the display apparatus has spread as a display apparatus for a portable terminal (for example, a mobile telephone).

By the way, especially in the case of a mobile terminal, because it is directly held or operated by an operator, it becomes easy to generate electrical discharge of static electricity on the display surface of the LCD device. The static electricity makes a circuit in the LCD device malfunction, or breaks it.

As one of the solutions of the above-mentioned problem, forming a protection circuit constituted with a plurality of protective diodes between a power input terminal near an electrode pad and a ground terminal in the LCD device is disclosed in Japanese Patent Application Laid-Open No. 1997-080471. Even if an electrostatic noise invades into an electrode pad and excessive forward current flows into it, destruction of an internal circuit, such as a drive circuit of the LCD device, can be prevented by this protection circuit.

On the other hand, in recent years, a value of voltage which is needed in order to operate a liquid crystal becomes higher than supply voltage of a general semiconductor device, and it is difficult to share a power supply of a system of a mobile terminal and a power supply which supplies voltage to the LCD device. Accordingly, it becomes necessary to provide a LCD device including a power supply circuit. For example, a liquid crystal control-driver IC (integrated circuit) including a source driver circuit having the power supply circuit is disclosed in Japanese Patent Application Laid-Open No. 2006-292807.

However, in case of the above-mentioned LCD device disclosed in Japanese Patent Application Laid-Open No. 2006-292807, because all circuits including a power supply circuit are integrated onto one chip, the wiring protection configuration disclosed in Japanese Patent Application Laid-Open No. 1997-080471 cannot be mounted later.

### SUMMARY

An exemplary object of the present invention is to provide a display apparatus with high resistance against static electricity.

According to an exemplary aspect of the invention, a display apparatus includes a substrate; a pixel matrix which is formed on the substrate; a plurality of circuit blocks which performs a predetermined function for driving the pixel matrix; a connection terminal which connects the display apparatus to an external circuit; a plurality of internal wirings which connects between the pixel matrix and the each circuit block, and connects between the circuit blocks, respectively; and a protective element which includes a first terminal and a second terminal at least. The first terminal is connected to at least one of the plurality of internal wirings, and the second terminal is connected to the external circuit via the connection terminal.

According to another exemplary aspect of the invention, a display apparatus includes a first substrate and a second substrate opposing the first substrate via a liquid crystal layer. The apparatus further includes a pixel matrix which is formed on the first substrate; a plurality of circuit blocks which performs a predetermined function for driving the pixel matrix; a connection terminal which connects the display apparatus to an external circuit; a plurality of internal wirings which connects between the pixel matrix and the each circuit block, and connects between the circuit blocks, respectively; and a protective element which includes a first terminal and a second terminal at least. The first terminal is connected to at least one of the plurality of internal wirings, and the second terminal is connected to the external circuit via the connection terminal.

According to another exemplary aspect of the invention, a display apparatus includes a substrate; a pixel matrix which is formed on the substrate, and includes a plurality of pixels which include a switching transistor, a storage capacitor, a drive TFT (thin-film-transistor), and an EL (electro-luminescence) diode arranging at each intersection of a data line and a gate line; a plurality of circuit blocks which performs a predetermined function for driving the pixel matrix; a connection terminal which connects the display apparatus to an external circuit; a plurality of internal wirings which connects between the pixel matrix and the each circuit block, and connects mutually the circuit blocks; and a protective element which includes a first terminal and a second terminal at least. The first terminal is connected to at least one of the plurality of internal wirings, and the second terminal is connected to the external circuit via the connection terminal.

### BRIEF DESCRIPTION OF THE DRAWINGS

Exemplary features and advantages of the present invention will become apparent from the following detailed description when taken with the accompanying drawings in which:

FIG. 1 is a block diagram showing an exemplary configuration of a display apparatus of a first embodiment according to the present invention;

FIG. 2 is a block diagram and a layout drawing showing an exemplary configuration of a display apparatus of a second embodiment according to the present invention;

FIG. 3 shows an example of cross-sectional view of A-A′ line of FIG. 2;

FIG. 4 is a graph showing characteristics of a protective element of the display apparatus shown in FIG. 2;

FIG. 5 is a circuit diagram showing an exemplary circuit of the protective element having the characteristics of FIG. 4;

FIG. 6 is a cross sectional view of A-A′ line of FIG. 2 of a display apparatus of a third embodiment according to the present invention;

FIG. 7 is a block diagram showing an exemplary configuration of a display apparatus of a fourth embodiment according to the present invention;

FIG. 8 is a block diagram showing an exemplary configuration of a display apparatus of a fifth embodiment according to the present invention;

FIG. 9 is a block diagram showing an exemplary configuration of a display apparatus of a sixth embodiment according to the present invention;

FIG. 10 is a block diagram showing an exemplary configuration of a display apparatus of a seventh embodiment according to the present invention;

FIG. 11 is a block diagram showing an exemplary configuration of a display apparatus of an eighth embodiment according to the present invention;

FIG. 12 is a block diagram showing an exemplary configuration of a display apparatus of a ninth embodiment according to the present invention;

FIG. 13 is a circuit diagram showing a first example of a circuit of a protective element of the display apparatus of the ninth embodiment according to the present invention;

FIG. 14 is a circuit diagram showing a second example of a circuit of the protective element of the display apparatus of the ninth embodiment according to the present invention;

FIG. 15 is a block diagram showing an exemplary configuration of a display apparatus of a tenth embodiment according to the present invention;

FIG. 16 is a block diagram showing an example of one configuration of a general display apparatus; and

FIG. 17 is a circuit diagram of a protective element generally used in the display apparatus shown in FIG. 16.

### EXEMPLARY EMBODIMENTS

In order to easily understand exemplary embodiments according to the present invention which are explained below, related arts are described first.

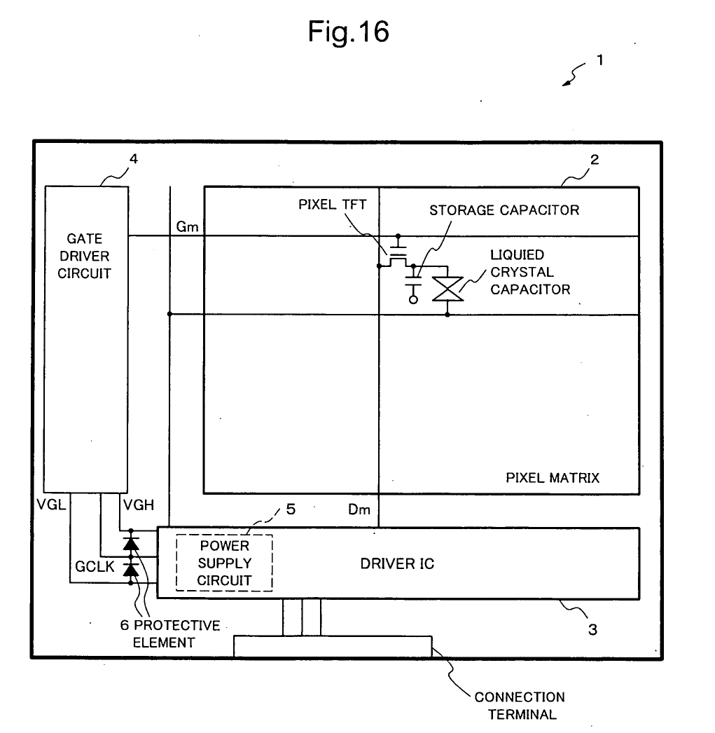

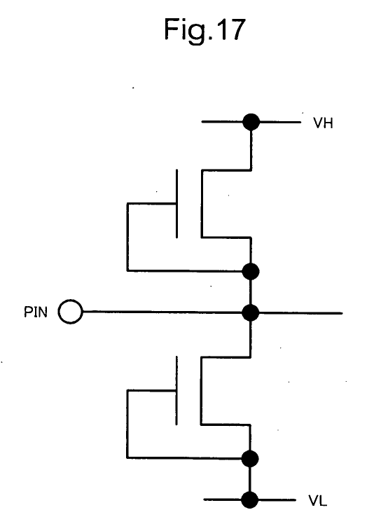

In a LCD device having an IC chip which installs a power supply circuit, a measure against static electricity as shown in FIG. 16 is taken. The LCD device 1 includes a substrate which mounts a pixel matrix 2, a driver IC 3, and a gate driver circuit 4. Here, a pixel is arranged on each intersection of data lines Dm and gate lines Gm arranged vertically and horizontally in the pixel matrix 2. Each pixel is formed with a pixel TFT, a liquid crystal capacitor, and a storage capacitor. The driver IC 3 supplies a video signal to the data lines Dm. The gate driver circuit 4 supplies gate pulses for controlling the pixel TFT to the gate lines Gm. In this case, power supply circuit 5 is built in driver IC 3, and supplies electric power for other circuits in the driver IC 3 and the gate driver circuit 4. And a protective element 6 is formed in a GCLK which is one of control signals of the gate driver circuit 4. The protective element 6 includes a first diode and a second diode. One end of the first diode connects to the GCLK. Other end of the first diode connects to a VGH which is a higher power supply for the gate driver circuit 4. One end of the second diode connects to the GCLK. Other end of the second diode connects to a VGL which is a lower power supply for the gate driver circuit 4. These first and second diodes are configured with TFTs performing diode connection as shown in FIG. 17, for example. When an electric charge by static electricity is impressed to the GCLK, the electric charge will be discharged in the power supply VGH or the power supply VGL via one of these two diodes according to polarity of the electric charge. The electric charge by the static electricity discharged in the VGH or the VGL is absorbed in the power supply circuit of the driver IC 3. Accordingly, high voltage is not applied on a circuit for driving the GCLK.

In recent years, a miniaturization of manufacturing process of an IC is developed to reduce cost and to save space of a driver IC. However, on the other hand, the miniaturization of the manufacturing process has brought about an injurious effect on resisting voltage reduction of a protective element in the driver IC. That is, the power supply circuit 5 which has the protective elements 6 whose resisting voltage are not enough in FIG. 16 cannot fully absorb the electric charge by static electricity. A capacitance of a wiring to which static electricity is discharged also becomes small with miniaturization of an LCD device, and rise of the voltage of the wiring by the electric charge impressed according to it becomes large. When the voltage of wiring exceeds an electric strength of the TFT, the TFT might be destroyed.

The aforementioned problem is solved by each exemplary embodiment of the present invention explaining in detail using drawings below.

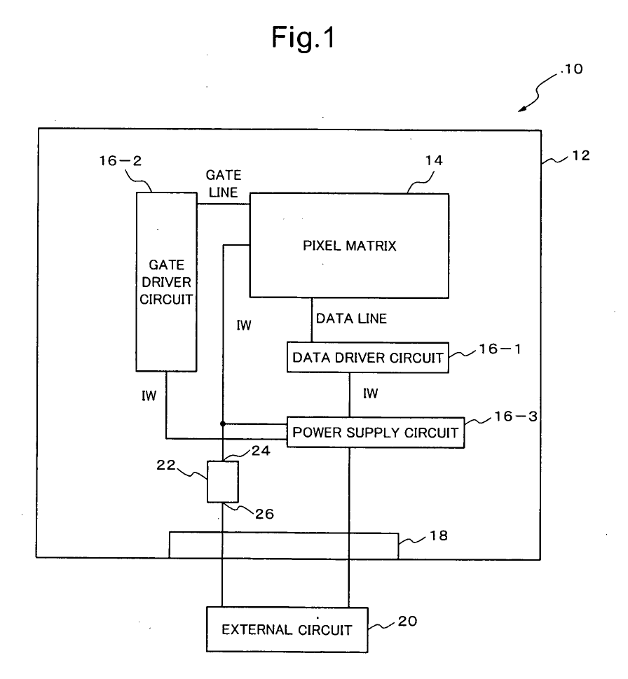

FIG. 1 is a block diagram showing an exemplary configuration of a display apparatus 10 of a first embodiment according to the present invention. The display apparatus 10 includes a substrate 12. The substrate 12 includes a pixel matrix 14, two or more circuit blocks 16-1˜n and a connection terminal 18. Two or more pixels including at least a switching element and a pixel electrode is arranged in a matrix shape in the pixel matrix 14. The circuit blocks 16-1˜n perform a predetermined process respectively. A data driver circuit as the circuit block 16-1 drives a data line of the pixel matrix 14. A gate driver circuit as the circuit block 16-2 drives a gate line of the pixel matrix 14. A power supply circuit as the circuit block 16-3 supplies electric power to each circuit. The connection terminal 18 is connected with a constant potential power supply of an external circuit 20 at least. Internal wirings IW connect between the pixel matrix 14 and the circuit block, and between the circuit blocks.

The display apparatus 10 further includes a protective element 22. The protective element 22 includes a first terminal 24 and a second terminal 26 at least. The first terminal 24 connects to at least one predetermined internal wiring IW. The second terminal 26 connects to the constant potential power supply of the external circuit 20 via the connection terminal 18.

When static electricity is discharged on the display apparatus 10 according to the above-mentioned configuration, the electric charge of the static electricity is discharged to the external circuit 20 via the protective element 22 connected to the internal wiring IW. Therefore, in the pixel matrix 14 or the circuit blocks 16-1˜n, the voltage rise by the electric charge of the static electricity is avoidable. As a result, probability that the display apparatus 10 will malfunction or break down by the static electricity can be reduced.

In this case, it is suitable if the protective element 22 is a protective element which has a nonlinear characteristic. The nonlinear characteristic is that a resistance value between terminals becomes small when a potential difference between the first terminal 24 and the second terminal 26 is more than a predetermined value, and the electrical resistance between the terminals becomes large when this potential difference is smaller than a predetermined value. As a protective element which has a nonlinear characteristic, a protective element which has a varistor or two zener diodes can be mentioned, for example. The protective element 22 constituted from the varistor or the zener diodes has a high electric strength to destruction, and its acceptable value of a current value which flows through the protective element 22 is also large. Therefore, the protective element 22 can correspond even to the quantity of electric charge of far larger static electricity compared with using the protective diode by TFT or using the protective element installed in the driver IC. Accordingly, the protective element 22 can improve further the resistance against the static electricity of the display apparatus 10.

The internal wiring which connects to the protective element 22 is an internal wiring (for example, an internal wiring of a large wiring area or an internal wiring to which an electrode of a large area is connected) in which static electricity is easy to be discharged as compared with other wiring. Thereby, in the display apparatus 10, it becomes possible to make still higher the resistance against the static electricity.

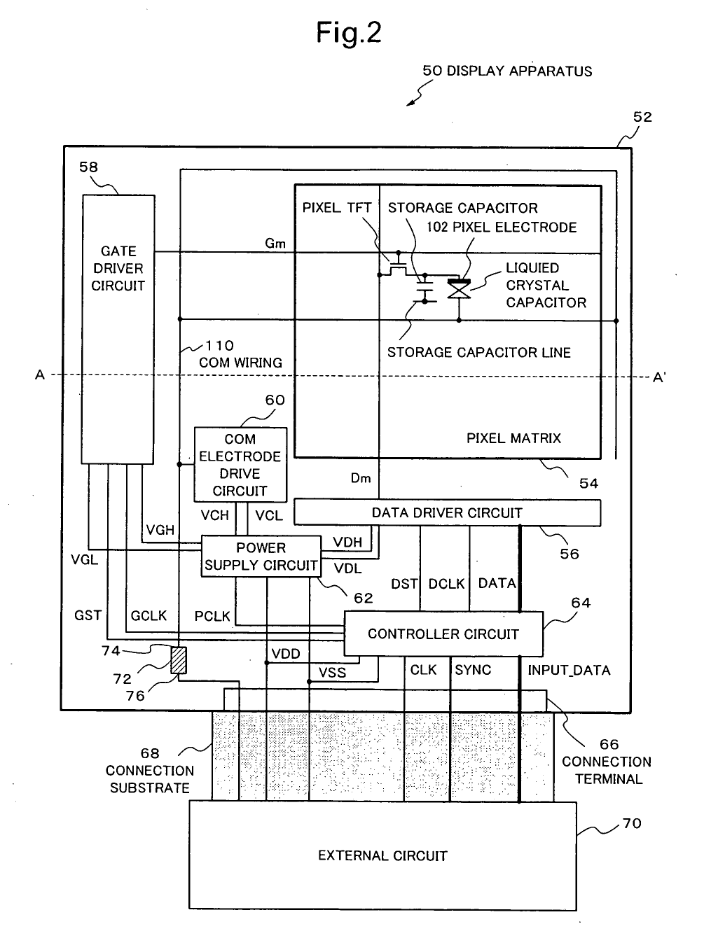

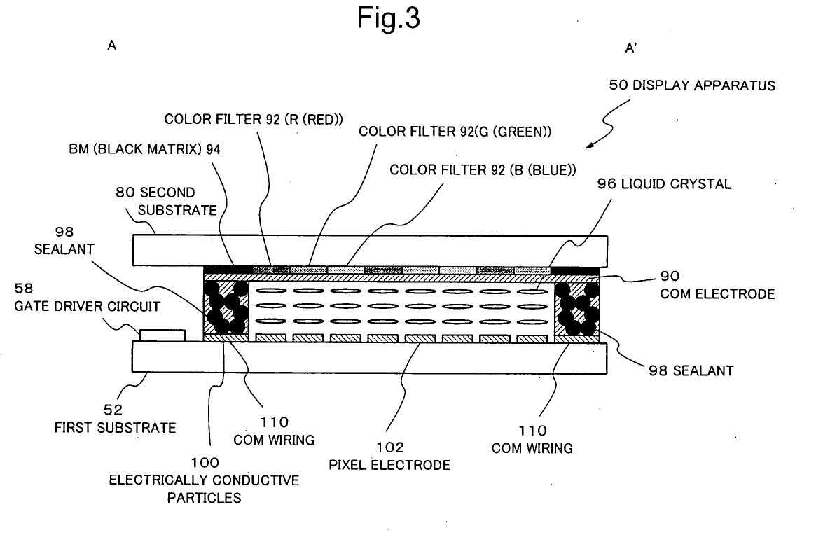

FIG. 2 is a block diagram and a layout drawing showing an exemplary configuration of a display apparatus 50 of a second embodiment according to the present invention. FIG. 3 shows an example of cross-sectional view of A-A′ line of FIG. 2. Here, the display apparatus 50 is an LCD device. The display apparatus 50 includes a first substrate 52 and a second substrate 80. The first substrate 52 and the second substrate 80 are arranged oppositely. A liquid crystal 96 intervenes between the first substrate 52 and the second substrate 80. The first substrate 52 includes a pixel matrix 54, a plurality of circuit blocks (for example, a data driver circuit 56, a gate driver circuit 58, a COM (common) electrode drive circuit 60, a power supply circuit 62, a controller circuit 64), and a connection terminal 66.

A plurality of pixels at least including a switching element (a TFT, for example) and a pixel electrode is arranged in a matrix shape in the pixel matrix 54. As understood from FIG. 2, each pixel includes a pixel TFT, a storage capacitor, a liquid crystal capacitor, and a pixel electrode 102 at least. Each pixel is arranged on each intersection of data lines Dm and gate lines Gm which are arranged vertically and horizontally, respectively. One terminal of the storage capacitor is connected to the pixel TFT, and the other terminal is connected to the storage capacitor line common to each pixel. Here, for example, the same electric potential as a COM electrode 90 (refer to FIG. 3) can be supplied to the storage capacitor line. The data driver circuit 56 drives the data line Dm. The gate driver circuit 58 drives the gate line Gm.

The COM electrode 90 for impressing a signal common to each pixel-is formed on a principal plane of the second substrate 80 (refer to FIG. 3). The COM electrode drive circuit 60 impresses a common signal to the COM electrode 90 via a COM wiring 110 formed on the first substrate 52. The power supply circuit 62 supplies an electric power to each circuit block. The controller circuit 64 controls each circuit block. The connection terminal 66 connects with an external circuit 70 via a connection substrate 68. For example, the first substrate 52 inputs a power supply (VDD, VSS) needed for operation, a synchronizing signal (SYNC), a video signal (INPUT_DATA), and the like from the external circuit 70 via the connection terminal 66 and the connection substrate 68. Aforementioned VDD, VSS, SYNC, and INPUT_DATA which show the name of a power supply or a signal are used also as a wiring name in explanations and drawings below. That is, for example, a power supply VDD is described as a power supply line VDD.

The display apparatus 50- adopts a TN (twisted nematic) mode or a VA (vertical alignment) mode as a liquid crystal mode. That is, the display apparatus 50 has the cross-sectional structure as shown in FIG. 3. The COM electrode 90 is formed on a principal plane of the second substrate 80. Each pixel electrode 102 formed on the first substrate 52 is arranged so that it may oppose with the COM electrode 90 formed on the second substrate 80 on both sides of the liquid crystal 96. Here, although the COM electrode 90 is not shown in FIG. 2, fundamentally, the electrode which is in the opposite side of the pixel electrode 102 in the liquid crystal capacitor is the COM electrode 90. Between the principal plane of the second substrate 80 and the COM electrode 90, color filters 92 (R (Red)), 92 (G (Green)) and 92 (B (Blue)), and a BM (Black Matrix) 94 are arranged. The first substrate 52 joins the second substrate 80 by a sealant 98. The COM electrode 90 of the second substrate 80 and the COM wiring 110 of the first substrate 52 are electrically connected by electrically conductive particles 100 added in the sealant 98. A polarizing plate (not shown) is arranged on a face of an opposite side of the face which touches the liquid crystal 96 of each substrate of the first substrate 52 and the second substrate 80. An alignment film (not shown) for orienting a molecule of liquid crystal 96 to a certain direction is applied on the surface of pixel electrode 102 and the COM electrode 90, respectively. When the display apparatus 50 is a so-called transmission type LCD device, a backlight (not shown) is arranged behind the polarizing plate of the first substrate 52. The liquid crystal capacity in this case consists of the COM electrode 90, the pixel electrode 102, and liquid crystal 96 arranged between them.

Further, the color filters 92 (R), 92 (G) and 92 (B) and the BM 94 are not necessarily required. The electric connection between the COM electrode 90 and the COM wiring 110 is not limited to the method of using the conductive particle 100 added in the sealant 98. For example, in a different position from the position in which the sealant 98 has been arranged, it is also electrically connectable by a conductive material, such as a silver paste.

As shown in FIG. 2, for example, the power supply circuit 62 connects with other circuit blocks via power supply lines VGH, VGL, VDH, VDL, VCH and VCL or a control signal line PCLK. Each circuit block is mutually connected by control signal lines GST, GCLK, DST, and DCLK, or a data line DATA, for example. Here, above-mentioned power supply lines VGH, VGL, VDH, VDL, VCH and VCL, the control signal lines PCLK, GST, GCLK, DST and DCLK, and the data line DATA are internal wirings (namely, wirings which not connect directly to the external circuit 70). On the other hand, the power supply circuit 62 connects with the connection terminal 66 via the power supply lines VDD and VSS which are the external wirings (namely, wirings which connect directly to the external circuit 70). The COM electrode drive circuit 60 is connected with the COM electrode 90 via the COM wiring 110 which is an internal wiring. Here, as mentioned above, in the case of this embodiment, the COM wiring 110 is formed in the first substrate 52, and the COM electrode 90 is formed in the second substrate 80.

The display apparatus 50 further includes a protective element 72. The protection element 72 includes a first terminal 74 and a second terminal 76 at least. The first terminal 74 is connected to at least one of a plurality of internal wiring mentioned above, and the second terminal 76 is connected to a constant potential power supply (not shown) of the external circuit 70 via the connection terminal 66.

That is, when static electricity is discharged on the surface of the second substrate 80 that is a display surface, the electric charge of static electricity is discharged to the external circuit 70 via the protective element 72 connected to the internal wiring. Therefore, in the pixel matrix 54 or each circuit block, a voltage rise by the electric charge of the static electricity is avoidable. As a result, probability that the display apparatus 50 will malfunction or break down by the static electricity can be reduced.

The inventors of the present invention found out that there is a wiring to which static electricity is easy to be discharged compared with other wirings of the wirings of a display apparatus, especially an LCD device through the experiment etc. In an LCD device like the TN mode or the VA mode specifically provided with a substrate with a pixel electrode, and a counter substrate with a COM electrode common to each pixel arranged so that it may oppose thereto via a liquid crystal layer, for example, it is found out that static electricity tends to be discharged to the COM electrode wiring. Also in an LCD device like an IPS (In-Plane-Switching) mode in which a COM electrode common to each pixel has been arranged in the same substrate as the substrate with a pixel electrode, it is found out that static electricity tends to be discharged to a COM electrode wiring. The reason that the static electricity tends to discharge to the COM electrode wiring is that in the case of the LCD device in the TN mode or the VA mode, the display surface to which the static electricity is discharged is the counter substrate, and accordingly, the probability that the static electricity will be discharged to the COM electrode arranged in the counter substrate becomes high. In the case of the LCD device of the IPS mode, it is because the COM electrode wiring is wiring of the largest area in the substrate of the LCD device. Based on the aforementioned knowledge, the example of connecting the first terminal 74 of the protective element 72 to the COM wiring 110 is shown in FIG. 2.

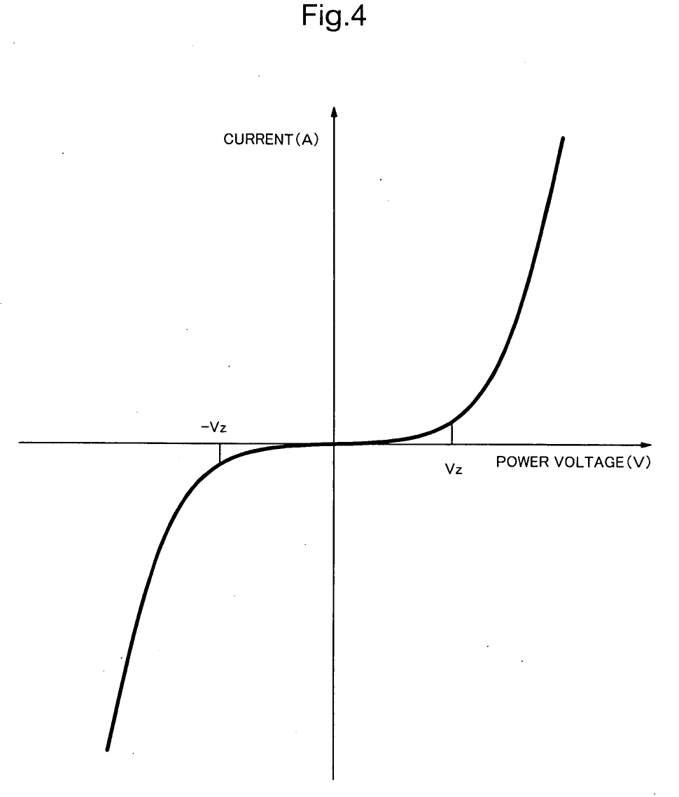

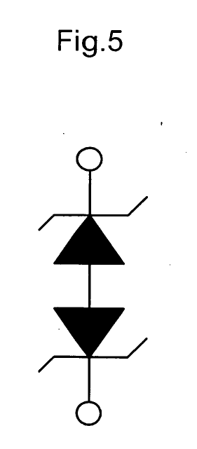

As the protective element 72, it is used the protective element having a nonlinear characteristic that the electrical resistance between terminals becomes small when the potential difference between the first terminal 74 and the second terminal 76 is more than a predetermined value, and the resistance between terminals becomes large when this potential difference is smaller than a predetermined value as shown in FIG. 4. As the protective element having the nonlinear characteristic, a varistor or the element which is composed of two zener diodes connected as shown in FIG. 5 can be mentioned, for example.

Here, a discharge operation of a static electricity of the protective element 72 which has the nonlinear characteristic which was mentioned above at the time of connecting the first terminal 74 to the COM wiring 110 is described. The voltage of the COM electrode 90 rises according to the capacitance of the COM electrode 90 and the quantity of the discharged electric charge, when the electric charge by static electricity is impressed to the COM electrode 90. However, the protective element 72 which has the nonlinear characteristic as shown in FIG. 4 is connected to the COM wiring 110. Accordingly, when the voltage of the COM wiring 110 becomes more than a certain fixed value, the electrical resistance between the first terminal 74 and the second terminal 76 of the protective element 72 will become very small, and the electric charge of the static electricity will be discharged to the external circuit 70 via the protective element 72. Accordingly, the voltage of COM wiring 110 ranges from −Vz(V) to +Vz(V), and it becomes possible to protect the COM electrode drive circuit 60 from malfunction or breaking down.

According to this embodiment, when the electric charge by static electricity is discharged on the display surface of display apparatus 50, this electric charge is discharged outside via the protective element 72 electrically connected to the COM wiring 110 connected to the COM electrode 90 with high probability that the static electricity will be discharged. Accordingly, a voltage increase by the electric charge does not arise in the COM electrode drive circuit 60 for driving the COM electrode 90. Therefore, a probability that the display apparatus 50 malfunctions or breaks down can be reduced substantially.

When a varistor and a zener diode are used as the protective element 72, the electric strength to destruction of the protective element 72 becomes high, and an acceptable value of the current which flows through the protective element 72 also becomes large. Therefore, the protective element 72 can correspond even to the quantity of electric charge of far larger static electricity compared with using the protective diode by TFT or using the protective element installed in the driver IC. That is, the protective element 72 can improve the resistance against the static electricity for the display apparatus 50. Here, as a voltage Vz in which the electrical resistance of the protective element 72 becomes small drastically, it is desirable to set it as the voltage larger than the range of the voltage usually impressed to the COM electrode 90 and lower than the electric strength of the COM electrode drive circuit 60.

The data driver circuit 56, the gate driver circuit 58, the COM electrode drive circuit 60, the power supply circuit 62, and the controller circuit 64 may be produced simultaneously with the pixel TFT using the same process as the process of producing the pixel TFT. Or the data driver circuit 56, the gate driver circuit 58, the COM electrode drive circuit 60, the power supply circuit 62, and the controller circuit 64 are also producible as a driver IC using a single crystal Si substrate.

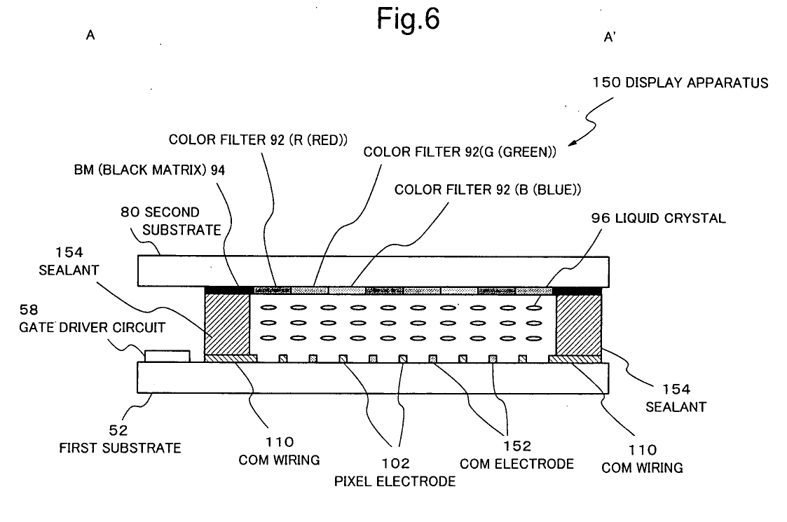

FIG. 6 is a cross sectional view of A-A′ line of FIG. 2 of a display apparatus 150 of a third embodiment according to the present invention. The IPS mode is used for this display apparatus 150 as a liquid crystal mode. Accordingly, the difference from the display apparatus 50 of the second embodiment that employs the TN or the VA mode is in an arrangement of each of pixel electrodes 102 and COM electrodes 152. In the display apparatus 150 of this embodiment, the COM electrodes 152 are arranged on a first substrate 52 and are not arranged on a second substrate 80. A conductive particle is not added in a sealant 154 for sticking the first substrate 52 and second substrate 80 together. The display apparatus 150 controls an oriented state of a liquid crystal molecule by a horizontal direction electric field parallel to each surface of the first substrate 52 and the second substrate 80 generated between the pixel electrodes 102 and the COM electrodes 152 on the first substrate 52. Because the circuit configuration and the wiring of the first substrate 52 of the display apparatus 150 are the same as that of the display apparatus 50, the explanation about them is omitted.

In the case of display apparatus 150, because the COM electrodes 152 are arranged on the first substrate 52 as mentioned above, an electric conductor does not exist on the second substrate 80. Accordingly, an electric charge by electric discharge of static electricity will be discharged to the electric conductor on the first substrate 52. The electric conductor with the largest area in the first substrate 52 is the COM electrode 152 arranged in common for all the pixels. That is, also in the IPS mode, the electric conductor with the highest probability that the electric charge by static electricity will discharge is the COM electrode 152. These are described by the above-mentioned inventor's knowledge. In the display apparatus 150 of this embodiment, a protective element 72 as shown in FIG. 2 is connected to the COM wiring 110 electrically connected to the COM electrodes 152 like the display apparatus 50 of the second embodiment. Even if an electric charge by static electricity is discharged, because this protective element 72 discharges the electric charge to the external circuit 70, the voltage of the COM wiring 110 does not up more than a voltage specified in the characteristics of the protective element 72. Therefore, it is possible to reduce substantially the probability that malfunction and destruction of the display apparatus 150 will occur. It is determined for a setup of voltage Vz in which the electrical resistance of the protective element 72 becomes small drastically by the same method as the method described in the first embodiment.

By the way, a thin film with very low conductivity is provided in some LCD devices of the IPS mode on the surface of the polarizing plate arranged on the second substrate 80. The reason of forming the thin film is to keep an electric charge charged by a certain factor from being charged on the surface of the second substrate 80 for a long time. However, because the electrical resistance of this conductive thin film is very high, the electric charge by the rapid electric discharge by static electricity cannot be missed in an instant, and the first substrate 52 is made to induce an electric charge by the electric field caused by the electric charge by this static electricity. However, the display apparatus 150 of this embodiment can discharge the electric charge caused by such electric field to the external circuit 70 via the protective element 72. Accordingly, also in the LCD device which provided the above thin film, the probability that malfunction and destruction will occur can be reduced substantially.

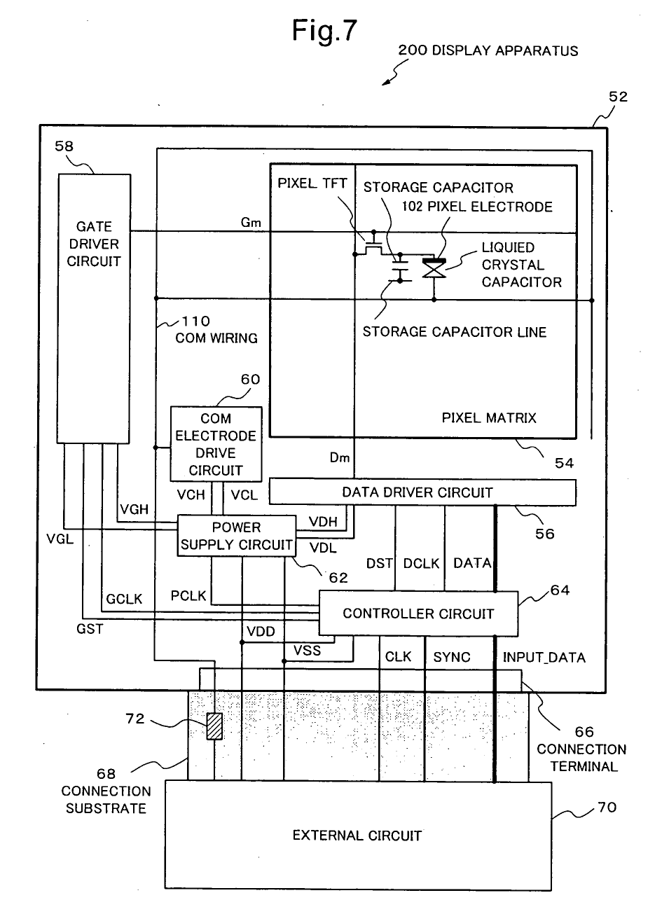

FIG. 7 is a block diagram showing an exemplary configuration of a display apparatus 200 of a fourth embodiment according to the present invention. A difference from the display apparatus 50 of the second embodiment of this display apparatus 200 is in the difference in a locating position of the protective element 72. While the protection element 72 is arranged on the first substrate 52 in the display apparatus 50, it is arranged on the connection substrate 68 in the display apparatus 200. Because a circuit configuration of a first substrate 52 and an arrangement of wirings, a pixel electrode 102, a COM electrode 90 is the same as the second embodiment, an explanation about them-is omitted.

In the display apparatus 200 of this embodiment in which the protective element 72 is arranged in the connection substrate 68, the probability of malfunction and destruction thereof by static electricity can be reduced substantially. Because the reason is already described in the second embodiment, an explanation thereof is omitted here.

In the display apparatus 200 of this embodiment, an advantageous effect that a display surface of the equipment incorporating this display apparatus 200 can be made flat is obtained. The reason will be described. The tallest part is the protective element 72 in the parts which constitute the display apparatus 200. The manufacturing process of the protective element 72 differs from the manufacturing process of the TFT and the driver IC which are formed on the first substrate 52. It is because the protective element 72 needs to have a high resisting voltage, and the thermal resistance with which it is not destroyed even if a current more than predetermined flows. For example, the varistor constituting the protective element 72 is produced by a greatly different process from the manufacturing process of a semiconductor device. The zener diode is produced by the semiconductor manufacturing process similar to a bipolar transistor unsuitable for the miniaturization. The package thereof also differs from that of other semiconductor devices so that it can cope with the temperature rise by current. For the above reason, the height of the protective element 72 will become high inevitably rather than other parts. As compared with such the protective element 72, most driver ICs are produced by the CMOS process advantageous to a miniaturization, and it is in the tendency which becomes much thinner further by polishing a Si substrate so that it may become below the original thickness. Accordingly, the height of protective element 72 will be embossed further. So, in the display apparatus 200 of this embodiment, the 5 protective element 72 which are tall parts is arranged not on the first substrate 52 but on the connection substrate 68. Thereby, the first substrate 52 includes only a thin IC produced by the miniaturization process. That is, the display surface of the equipment incorporating the display apparatus 200 can be made flat.

In this case, it becomes possible further by using a flexible substrate for the connection substrate 68 to fold it up to the rear-face side of the display apparatus 200. Thereby parts are not arranged at a position higher than the display surface of the display apparatus 200, and it becomes possible to make flat the display surface of the equipment incorporating the display apparatus 200.

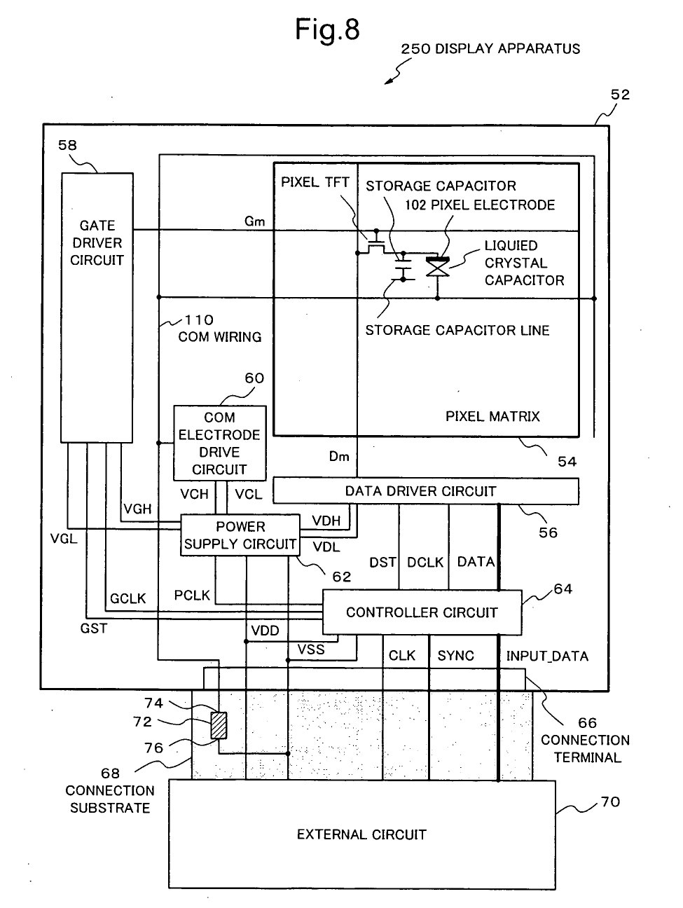

FIG. 8 is a block diagram showing an exemplary configuration of a display apparatus 250 of a fifth embodiment according to the present invention. The difference of this display apparatus 250 form the display apparatus 50 of the second embodiment is in the point that a connection destination of the second terminal 76 of the protective element 72 differs. In the display apparatus 250, the second terminal 76 is connected to a power supply line VSS which is an external wiring. That is, by using the destination for electrostatic discharges as the existing external power (an external power needed to drive the display apparatus 250), it is unnecessary to arrange a new power supply for electrostatic discharges, and miniaturization and cost reduction can be realized. In this case, the connection destination of the second terminal 76 is not limited to the power supply line VSS, but if it is a power supply line connected to the power supply of an external circuit, the same advantageous effect can be obtained. For example, the connection destination of the second terminal 76 can be set to a power supply line VDD. Of course, even if the second terminal 76 is connected to the power supply line VSS or the power supply line VDD, the electrostatic resistance of the display apparatus 250 does not fall as compared with that of other embodiment. In FIG. 8, although the protective element 72 is arranged on the connection substrate 68, this is only an example and it can be also arranged on the first substrate 52 like the second embodiment, for example.

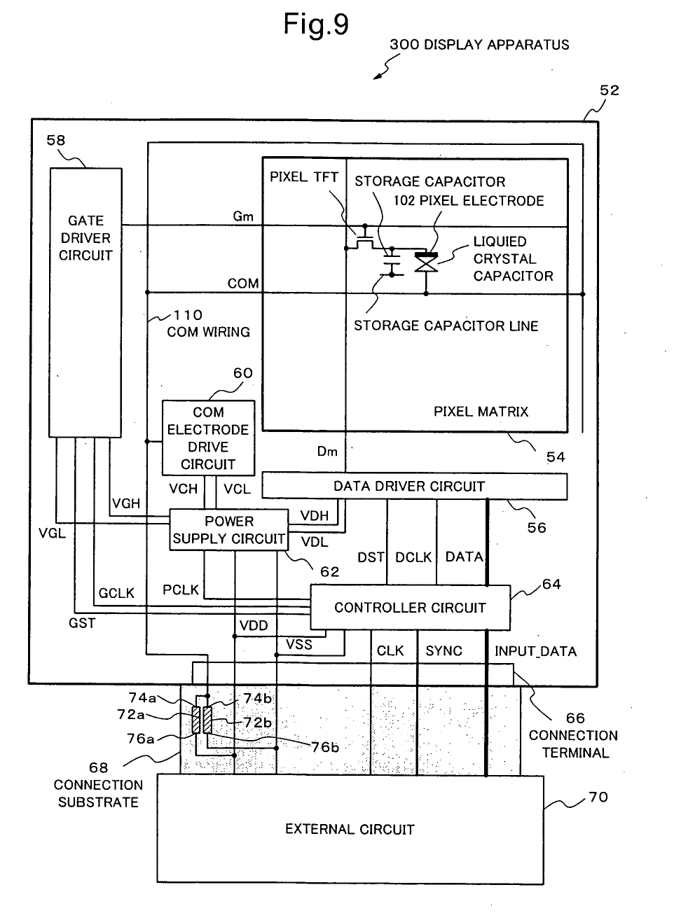

FIG. 9 is a block diagram showing an exemplary configuration of a display apparatus 300 of a sixth embodiment according to the present invention. The difference of this display apparatus 300.from the display apparatus 50 of the second embodiment is in the point that two protective elements are used and they are connected to two power source wirings for supplying a supply voltage to circuits on the display apparatus 300 from the outside, respectively. Specifically, two protective elements 72a and protective element 72b are provided, each first terminals 74a and 74b of the protective elements 72a and 72b is connected to the COM wiring 110, a second terminal 76a of the protective element 72a is connected to a power supply line VDD, and a second terminal 76b of the protective element 72b is connected to a power supply line VSS.

The inventors found out a regularity that current flows into one of two protective elements more with the polarity of the discharged electric charge through the experiment which discharges an electric charge artificially to on the display surface of the display apparatus 300. Specifically, the inventors obtained the knowledge that the protective element connected to the power supply near the voltage of the discharged electric charge tends to pass an electric charge.

It was decided to provide two protective elements based on this knowledge, as mentioned above. By adopting such a configuration, a higher resistance against discharge of the electric charge of minus and also against discharge of the electric charge of plus can be obtained. That is, even when the electric charge by static electricity is discharged by the surface of the second substrate 80 that is a display surface, it becomes possible to reduce more drastically the probability that the circuits arranged on the display apparatus 300 malfunction or destroy.

In FIG. 9, although the protective element 72a and the protective element 72b are arranged on the connection substrate 68, this is only an example, they can be also arranged on the first substrate 52 like the second embodiment, for example.

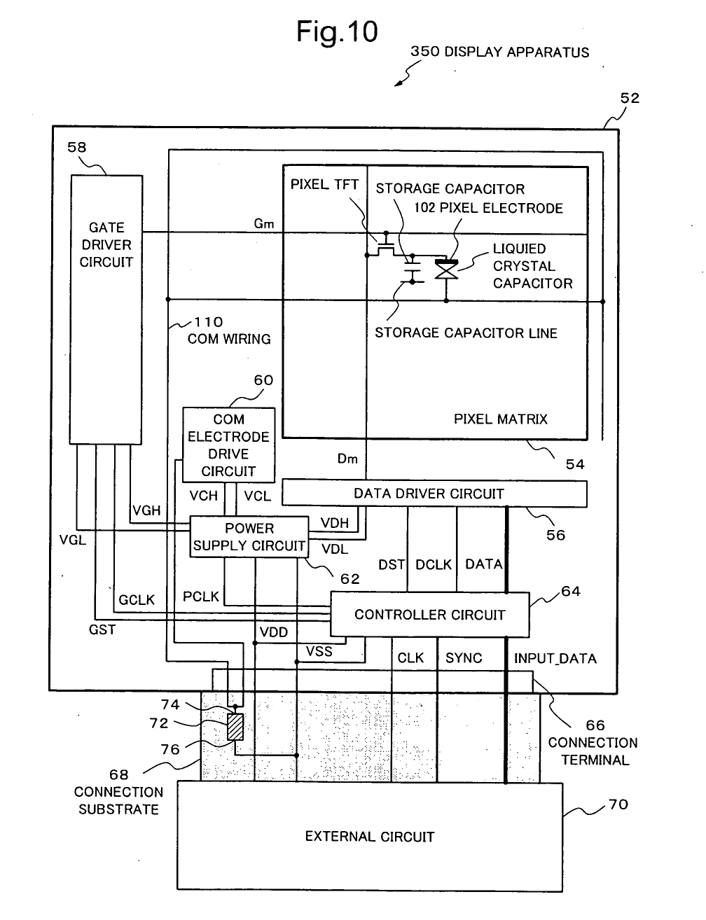

FIG. 10 is a block diagram showing an exemplary configuration of a display apparatus 350 of a seventh embodiment according to the present invention. The difference of this display apparatus 350 from the display apparatus 50 of the second embodiment is in a connection method of the COM wiring 110 connected to the first terminal 74 of the protective element 72. Specifically in this display apparatus 350, the COM wiring 110 from the output terminal of the COM electrode drive circuit 60 is first connected to the first terminal 74 of the protective element 72 in advance of connecting the COM electrode 90, and then it is connected to the COM electrode 90. By wiring the COM wiring 110 in this way, the wiring resistance value from the COM electrode 90 to the protective element 72 becomes certainly smaller than the wiring resistance value from the COM electrode 90 to the COM electrode drive circuit 60. An electric charge by static electricity has the characteristic of discharging through a course with a low electrical resistance. Because the electrical resistance from the COM electrode 90 to the protective element 72 certainly becomes smaller as mentioned above in the case of the display apparatus 350, before impressing a high voltage to the COM electrode drive circuit 60, the protective element 72 discharges the electric charge by static electricity. Accordingly, it becomes possible to prevent the malfunction and the destruction of a circuit by static electricity more effectively.

In FIG. 10, although the protective element 72 is arranged on the connection substrate 68, this is only an example, it can be also arranged on the first substrate 52 like the second embodiment, for example.

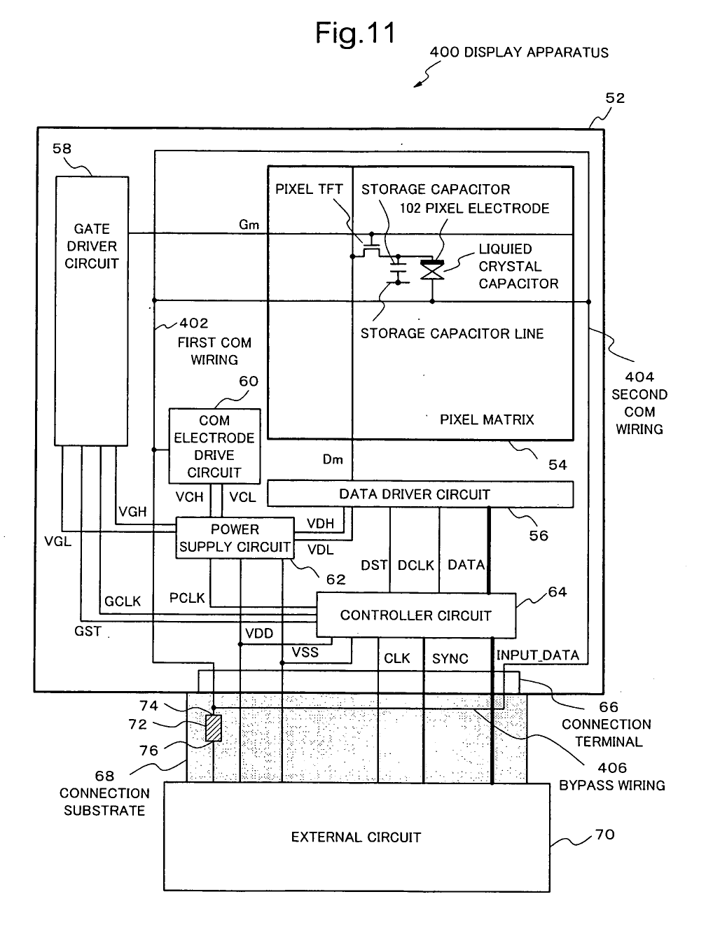

FIG. 11 is a block diagram showing one configuration example of a display apparatus 400 of an eighth embodiment according to the present invention. In the display apparatus 400, the COM wirings connected to the COM electrode 90 are arranged on two predetermined sides of the display apparatus 400. Specifically, a first COM wiring 402 and a second COM wiring 404 are arranged on each of a pair of the opposing sides except for the side on which a connection terminal 66 is formed on the first substrate 52. The COM electrode drive circuit 60 is arranged near the first COM wiring 402. The first COM wiring 402 is connected with the second. COM wiring 404 via a bypass wiring 406 formed on the connection substrate 68. The bypass wiring 406 is connected with the first terminal 74 of the protective element 72.

By the way, generally in the display apparatus having a COM electrode common to each pixel, the brightness of a pixel may vary by its position. The potential difference in the COM electrode can be mentioned as one of the causes. Although it is necessary to supply uniformly the optimal voltage or voltage waveform defined according to a driving method to a COM electrode, potential difference will arise by an electrical resistance therebetween based on a distance from a COM electrode drive circuit. In order to prevent this, it is effective to make an electrical resistance of a wiring such as a COM wiring small, but for that purpose, it is necessary to enlarge a wiring area, to thicken thickness, or to use a metal with high conductivity as a metal used for wiring. However, when the wiring area is enlarged, there is a fear of enlargement of a display apparatus. If thickness increases, the metal may be peeled off by the stress. There are restrictions on a manufacturing process using a metal, such as Cu with high conductivity. In a display apparatus, although Al, Cr and those alloys are usually used as a wiring, but Cu with high conductivity is not used. This is because the dry etching technology of Cu is not established.

In the case of the display apparatus 400 of this embodiment, voltage is supplied to the COM electrode from two sides of the panel at least with the bypass wiring 406 provided in the connection substrate 68. In the flexible substrate generally used as the connection substrate 68, Cu can be used for a wiring. This is because the wiring size on the flexible substrate is far large as compared with the wiring in an LCD device, and the wiring inside a driver IC and a wet etching process can be used as a result. Therefore, in the case of the display apparatus 400 of this embodiment, the electrical resistance of the COM wiring can be made small and as a result, the problem that the brightness of a pixel varies by a position thereof can be solved. Even when the electric charge by static electricity is discharged by the surface of the second substrate 80 that is a display surface like other embodiment, it becomes possible to reduce drastically the probability of malfunction or destruction of the circuit etc. arranged on the display apparatus 400.

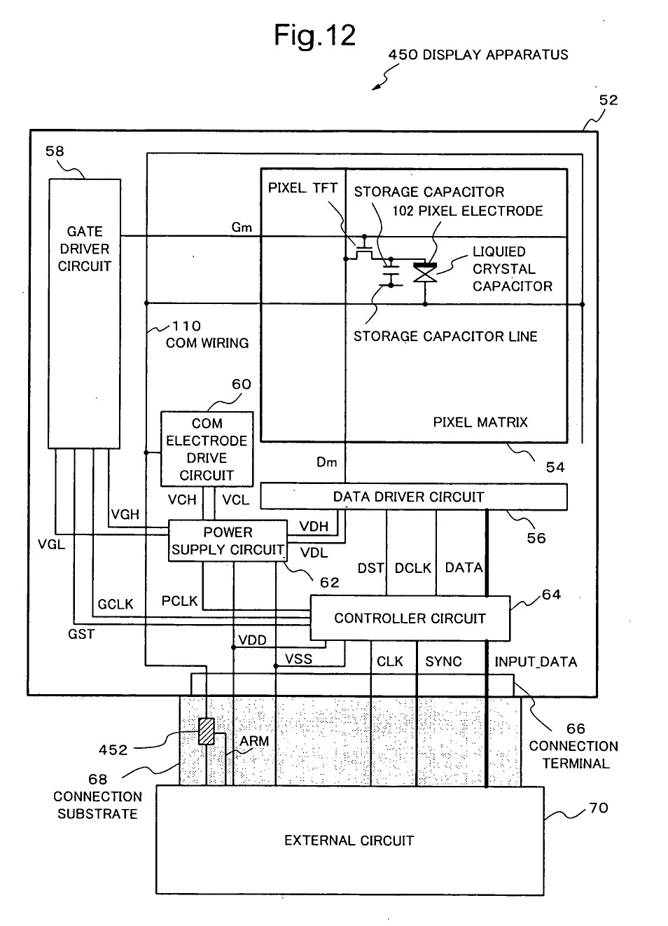

FIG. 12 is a block diagram showing an exemplary configuration of a display apparatus 450 of a ninth embodiment according to the present invention. This display apparatus 450 is provided with a protective element 452. In addition to the fundamental function of the protective element 72 described above, the protective element 452 is provided with a function for outputting an abnormal signal ARM according to the difference voltage between the potential of the COM wiring 110 connected to the first terminal and a predetermined reference voltage.

By having the protection element 452 mentioned above, the reliability of the display apparatus 450 can be improved. The reason will be described. Even if the COM electrode drive circuit 60 has malfunctioned, an operator may be unable to distinguish easily whether it has malfunctioned depending on an image which the display apparatus 450 displays. As such an image, there is an image which displays black etc. on the whole screen. In such a case, if an operator does not perform the reset action of equipment, a DC electric field may be continuously applied to a liquid crystal. If the DC electric field is continuously applied to the liquid crystal, the fault on the reliability of generating an impurity ion by decomposition of the liquid crystal, etc. will arise. In the case of this embodiment, by monitoring the output abnormality of the COM electrode drive circuit 60, it become possible to perform the reset action of the display apparatus 450 compulsorily, or to urge an operator to perform the reset action by reporting an occurrence of the abnormality with the equipment incorporating the display apparatus 450 when the abnormality thereof is detected. Therefore, a time to apply the DC electric field to the liquid crystal continuously can be shortened, and it becomes possible to improve the reliability of the display apparatus 450.

The object from which a voltage abnormality is detected by the protective element 452 is not be limited to the COM wiring 110, but other internal wiring may be the object. The arrangement position of the protective element 452 is not limited to the connection substrate 68, but can also be arranged on the first substrate 52.

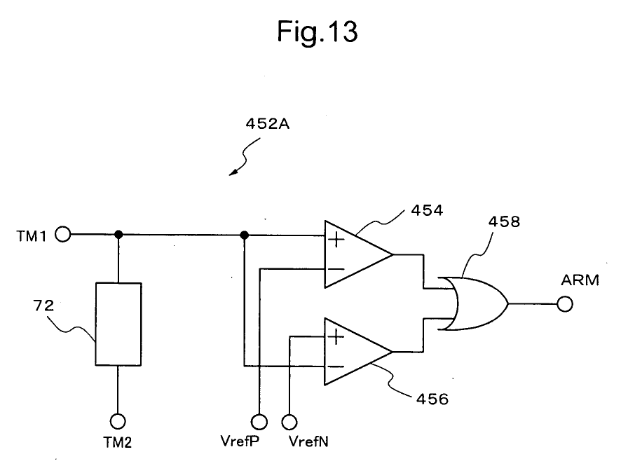

FIG. 13 is a circuit diagram showing a first example of a circuit of the protective element 452 in this embodiment. The protective element 452A includes the protective element 72 described above, a first operational amplifier 454 and a second operational amplifier 456 for detecting a difference from a reference voltage, and a logic circuit 458. In the protective element 452A, a terminal TM1 is connected with the COM wiring 110, and a terminal TM2 is connected with a constant potential power supply of the external circuit 70. An output of the first operational amplifier 454 rises to near a supply voltage by the side of the positive polarity of the operational amplifier when the voltage of the terminal TM1 is larger than a first reference voltage VrefP. The output of the first operational amplifier 454 becomes near a supply voltage by the side of the negative polarity of the operational amplifier when the voltage of the terminal TM1 is smaller than the first reference voltage VrefP. On the other hand, when the voltage of the terminal TM1 is smaller than a second reference voltage VrefN, an output of the second operational amplifier 456 becomes near a supply voltage by the side of the positive polarity. When the voltage of the terminal TM1 is larger than the second reference voltage VfefN, the output of the second operational amplifier 456 becomes near a supply voltage by the side of the negative polarity of the operational amplifier. The logic circuit 458 takes a logical sum of the output of the first operational amplifier 454 and the second operational amplifier 456 by which the level shift was done if needed. Thereby, the output of the logic circuit 458 (namely, the abnormal signal ARM) becomes as a High level (that is, active), when the voltage of the terminal TM1 is larger than the first reference voltage VrefP, or when smaller than the second reference voltage VrefN. Here, it becomes possible to detect by the abnormal signal ARM whether the abnormality is arisen in the voltage of the COM wiring 110 by setting the first reference voltage VrefP as the voltage a little larger than the maximum in the voltage span regularly impressed to the COM wiring 110, and by setting the second reference voltage VrefN as the voltage a little smaller than the minimum in this voltage span. The first reference voltage VrefP and the second reference voltage VrefN may be generated by dividing a voltage of an arbitrary supply voltage by a resistor, or may be generated by a DAC circuit etc. A comparator can be used instead of the operational amplifier.

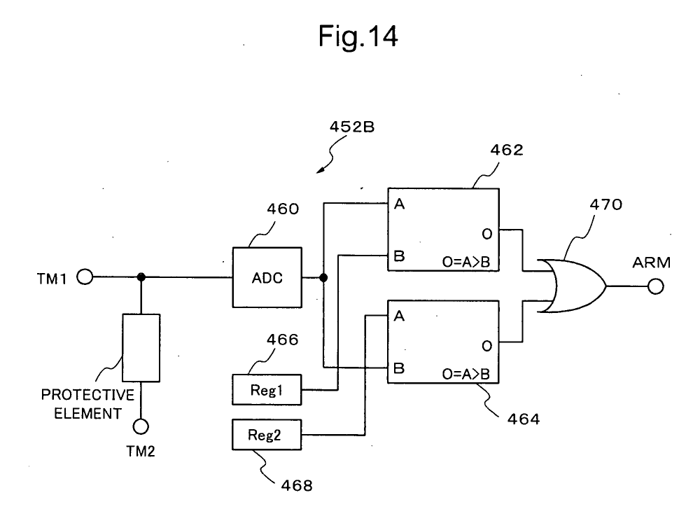

FIG. 14 is a circuit diagram showing a second example of a circuit of the protective element 452 in this embodiment. The protective element 452B includes the protective element 72 described above, an analog to digital converter (ADC) 460, a first digital comparator 462, a second digital comparator 464, a first register 466 holding a first reference value Reg1, a second register 468 holding a second reference value Reg2, and a logic circuit 470. A terminal TM1 is connected with the COM wiring 110. A terminal TM2 is connected with a constant potential power supply of the external circuit 70. A voltage of the terminal TM1 is converted into a digital signal in the ADC 460. The voltage of the terminal TM1 as a digital signal is compared with the first reference value Reg1 set as the first register 466 in the first digital comparator 462. The voltage of the terminal TM1 as a digital signal is compared with the second reference value Reg2 set as the second register 468 in the second digital comparator 464. The first digital comparator 462 outputs the signal of a High level, when the voltage of the terminal TM1 is larger than the first reference value Reg1, and when small, it outputs the signal of a Low level. The second digital comparator 464 outputs the signal of a High level, when the voltage of the terminal TM1 is smaller than the second reference value Reg2, and when large, it outputs the signal of a Low level. The logic circuit 470 takes a logical sum of the output of the first digital comparator 462 and the second digital comparator 464. Thereby, the output (namely, the abnormal signal ARM) of the logic circuit 470 becomes as a High level (that is, active), when the voltage of the terminal TM1 is larger than the first reference value Reg1, or when smaller than the second reference value Reg2. Here, it becomes possible to detect whether the abnormality is arisen or not in the voltage of the COM wiring 110 through the output of the abnormal signal ARM by setting the first reference value Reg1 as a voltage a little larger than the maximum in the voltage span which is impressed to the COM wiring 110 regularly and by setting the second reference value Reg2 as a voltage a little smaller than the minimum in the voltage span which is impressed to the COM wiring 110 regularly. The first reference value Reg1 and the second reference value Reg2 are also memorized in a volatile memory etc. The logic of the abnormal signal ARM which reports the abnormality of the COM wiring voltage, may be described by negative logic. The output of the first digital comparator 462 and the second digital comparator 464 can also be described by negative logic if consistency is taken logically.

Although the example for protecting the COM wiring 110 by the protective element has been shown in the second embodiment to the ninth embodiment of the present invention described so far, the wiring protected is not limited to the COM wiring 110. An internal wiring other than the COM wiring (for example, power supply lines VGH, VGL, VDH, VDL, VCH and VCL, control signal lines PCLK, GST, GCLK, DST and DCLK, and a data line DATA) can also be protected by the protective element.

Especially an electrode (an electrode of the opposite side of the electrode connected with the pixel TFT) that forms a storage capacitor, for example with reference to FIG. 2 is electrically connected to a storage capacitor line. Here, because a storage capacitor line is connected common to the,storage capacitor of all the pixels, the wiring area thereof becomes large after the COM wiring. Accordingly, an advantageous effect of large circuit protection is obtained by connecting the protective element to the storage capacitor line.

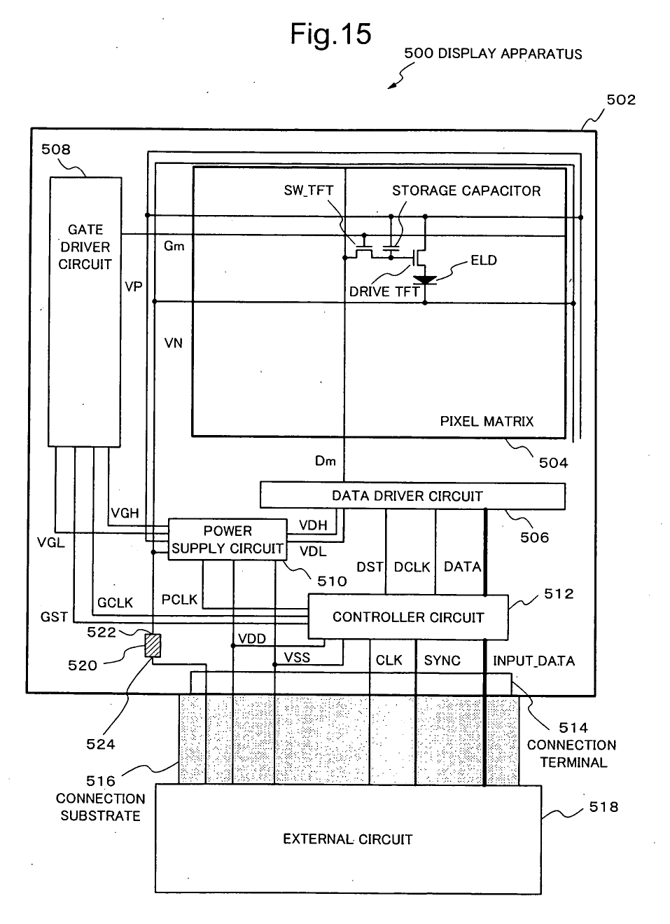

FIG. 15 is a block diagram showing an exemplary configuration of a display apparatus 500 of a tenth embodiment according to the present invention. The display apparatus 500 is an EL (electro-luminescence) display apparatus. The display apparatus 500 is provided with a substrate 502. The substrate 502 includes a pixel matrix 504, a plurality of circuit blocks (a data driver circuit 506, a gate driver circuit 508, a power supply circuit 510 and a controller circuit 512, for example) and a connection terminal 514.

The pixel matrix 504 arranges a plurality of pixels including switching elements at least in a matrix shape. That is, each pixel is provided with a switching transistor (henceforth an SW_TFT), a storage capacitor, a drive TFT, and an EL diode (henceforth ELD) at least as understood from FIG. 15. Each pixel is arranged on each intersection of the data lines Dm and the gate lines Gm arranged vertically and horizontally, respectively. In FIG. 15, in order to explain plainly, as for data lines Dm and gate lines Gm, although only one is illustrated, respectively, a plurality of data lines Dm and gate lines Gm are arranged actually. The data driver circuit 506 drives the data line Dm. The gate driver circuit 508 drives the gate line Gm. 5 The power supply circuit 510 supplies electric power to each circuit block. The controller circuit 512 controls each circuit block. The connection terminal 514 connects with an external circuit 518 via a connection substrate 516. For example, the substrate 502 inputs a power supply (VDD and VSS), a synchronization signal (SYNC) and a video signal (INPUT_DATA) or the like required to operation from the external circuit 518 via the connection terminal 514 and the connection substrate 516. Aforementioned VDD, VSS, SYNC, and INPUT_DATA which show the name of a power supply or a signal are used also as a wiring name in the following explanation and a drawing. That is, for example, the power supply VDD is described to be a power supply line VDD.

For example, the power supply circuit 510 connects with the pixel matrix 504 and other circuit blocks via power supply lines VGH, VGL, VDH, VDL, VP and VN or a control signal line PCLK. Each circuit block is mutually connected by controlling signal lines GST, GCLK, DST, and DCLK, or a data line DATA, for example. Here, above-mentioned power supply line VGH, VGL, VDH, VDL, VP and VN, control signal lines PCLK, GST, GCLK, DST, and DCLK, and data line DATA are internal wirings (namely, wirings not connected directly to the external circuit 518). On the other hand, the power supply circuit 510 is connected with the connection terminal 514 via the power supply lines VDD and VSS which are external wirings (namely, wirings connected directly to the external circuit 70).

The display apparatus 500 is further provided with a protective element 520. The protective element 520 includes a first terminal 522 and a second terminal 524 at least. The first terminal 522 is connected to at least one of a plurality of internal wirings mentioned above, and the second terminal 524 is connected to a constant potential power supply (not shown) of the external circuit 518 via the connection terminal 514.

Operation of the display apparatus 500 will be described briefly. An on-off control of the SW_TFT arranged in each pixel is performed by the gate driver circuit 508. When the gate driver circuit 508 scans the gate lines Gm sequentially, the voltage written in the data line Dm via the SW_TFT of each pixel is sampled by the storage capacitor. According to this sampled voltage, the current which flows into the ELD is controlled by the drive TFT, and displaying is performed. By performing this operation for all the gate lines Gm, it becomes possible to display the image for one screen.

That is, according to the configuration explained above, when static electricity is discharged to the display apparatus 500, the electric charge of static electricity is discharged to the external circuit 518 via the protective element 520 connected to the internal wiring. Accordingly, the voltage increase by the electric charge of the static electricity in the pixel matrix 504 or each circuit block can be avoided, and as a result, it becomes possible to reduce the probability that the display apparatus 500 will malfunction or destroy.

Here, the inventors have noticed that there is the internal wiring in which static electricity tends to be discharged compared with other wirings in the wirings of the display apparatus, especially the EL display. Concretely, the internal wiring is a power supply line VN connected to each ELD in common. The first reason that the static electricity tends to be discharged to the power supply line VN is because the power supply line VN is connected in common with all the ELDs, and the wiring area thereof is large as compared with other wirings. The second reason is -because a transparent conductive film is usually used for the terminal of ELD connected to the power supply line VN and it is arranged on the luminescent surface side. Based on the aforementioned knowledge, the example of connecting the first terminal 522 of the protective element 520 to the power supply line VN is shown in FIG. 15.

As shown in FIG. 4, as the protective element 520, it is used the protective element with the nonlinear characteristic that the resistance between the first terminal 522 and the second terminal 524 becomes small when the potential difference therebetween is more than a predetermined value, and the electrical resistance therebetween becomes large when this potential difference is smaller than a predetermined value. As the protective element which has a nonlinear characteristic, the varistor and the element composed of two zener diodes connected as shown in FIG. 5 can be mentioned, for example.

The discharge operation of the static electricity of protective element 520 with the nonlinear characteristic mentioned above whose first terminal 522 was connected to the power supply line VN will be described. If the electric charge by static electricity is impressed to the power supply line VN, the voltage of the power supply line VN will rise according to the capacitance of the power supply line VN, and the quantity of the discharged electric charge. However, the protective element 520 with the nonlinear characteristic as shown in FIG. 4 is connected to the power supply line VN. Accordingly, when the voltage of power supply line VN becomes more than a fixed value, the electrical resistance between the first terminal 522 and the second terminal 524 of the protective element 520 becomes very small, and the electric charge of static electricity is discharged to the external circuit 518 via the protective element 520. Therefore, the voltage of the power supply line VN ranges from −Vz (V) to +Vz (V), and it becomes possible to the protect power supply circuit 510 from malfunction or destruction.

The inventors found out that the internal wiring with a large area next to the power supply line VN in the wirings of the EL display is the power supply line VP which is a power supply line common to each pixel. The same low resistance metal wiring used for the data line Dm or the gate line Gm is used for the wiring of the power supply line VP. Accordingly, the area of power supply line VP is smaller than the power supply line VN. However, the area of power supply line VP is overwhelmingly large compared with other wiring, and is a large area next to the power supply line VN. Therefore, the probability that the electric charge by static electricity will be discharged in the power supply line VP will become high next to the power supply line VN. Accordingly, it becomes possible like the advantageous effect at the time of connecting the protective element 520 to the power supply line VN by connecting the protective element 520 to the power supply line VP to reduce drastically the malfunction and destruction by static electricity of the EL display.

Of course, the wiring of the subject of protection by the protective element 520 is not limited to the power supply line VN or power supply line VP mentioned above, and other internal wirings (for example, power supply lines VGH, VGL, VDH and VDL, control signal lines PCLK, GST, GCLK, DST and DCLK, a data line DATA, etc.) can be made into the subject thereof.

Here, as for the voltage Vz in which the electrical resistance of the protective element 520 becomes small drastically, it is desirable set up it as a voltage larger than the range of the voltage usually impressed to the power supply VN or VP, and lower than the resisting voltage of the power supply circuit.

There is an example for which the current copier circuit for copying the current which flows into the data line Dm in addition to the configuration shown in FIG. 15 and the display apparatus 500 of this embodiment described above is applicable also to the configuration using the current copier circuit.

The data driver circuit 506, the gate driver circuit 508, the power supply circuit 510, and the controller circuit 512 may be produced simultaneously with an SW_TFT and a drive TFT using the same manufacturing process as that of these TFT. Or the data driver circuit 506, the gate driver circuit 508, the power supply circuit 510, and the controller circuit 512 are also producible as a driver IC using a single crystal Si substrate.

According to the first embodiment to the tenth embodiment of the present invention described above, the resistance against the static electricity for the display apparatus, such as an LCD device and an EL display, can be improved, and consequently, performance of various kinds of information devices, such as a communication terminal, a mobile terminal, a liquid crystal display monitor, etc. incorporating such a display apparatus, can be also improved.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A display apparatus, comprising:
a substrate;
a pixel matrix which is formed on said substrate;
a plurality of circuit blocks which performs a predetermined function for driving said pixel matrix;
a connection terminal which connects said display apparatus to an external circuit;
a plurality of internal wirings which connects between said pixel matrix and said each circuit block, and connects between said circuit blocks, respectively; and
a protective element which includes a first terminal and a second terminal at least;
wherein said first terminal is connected to at least one of said plurality of internal wirings, and said second terminal is connected to said external circuit via said connection terminal.

2. The display apparatus according to claim 1, wherein
said protective element has a nonlinear characteristic that an electrical resistance between said first terminal and said second terminal becomes small when a potential difference therebetween is more than a predetermined value, and said electrical resistance therebetween becomes large when said potential difference is smaller than said predetermined value.

3. The display apparatus according to claim 2, wherein
said protective element includes any one of a. varistor and a zener diode.

4. The display apparatus according to claim 1, wherein
said first terminal of said protective element is connected to at least one internal wiring to which static electricity is discharged easily compared with other internal wirings.

5. The display apparatus according to claim 4, wherein
said internal wiring to which said static electricity is discharged easily is an internal wiring with a large wiring area or an internal wiring connected to an electrode with a large area.

6. A display apparatus including a first substrate and a second substrate opposing said first substrate via a liquid crystal layer, the apparatus comprising:
a pixel matrix which is formed on said first substrate;
a plurality of circuit blocks which performs a predetermined function for driving said pixel matrix;
a connection terminal which connects said display apparatus to an external circuit;
a plurality of internal wirings which connects between said pixel matrix and said each circuit block, and connects between said circuit blocks, respectively; and
a protective element which includes a first terminal and a second terminal at least;
wherein said first terminal is connected to at least one of said plurality of internal wirings, and said second terminal is connected to said external circuit via said connection terminal.

7. The display apparatus according to claim 6, wherein
said second terminal of said protective element is connected to a constant potential power supply of said external circuit.

8. The display apparatus according to claim 6, wherein
said second terminal of said protective element is connected to a wiring for supplying a power supply voltage or a ground potential from an outside to any one circuit block in said plurality of circuit blocks.

9. The display apparatus according to claim 6, wherein
said protective element has a nonlinear characteristic that an electrical resistance between said first terminal and said second terminal becomes small when a potential difference therebetween is more than a predetermined value, and said electrical resistance therebetween becomes large when said potential difference is smaller than said predetermined value.

10. The display apparatus according to claim 9, wherein
said predetermined voltage is a voltage broader than a range of voltage usually impressed to said internal wiring connected to said first terminal of said protective element and lower than a electric strength of said circuit block for driving said internal wiring.

11. The display apparatus according to claim 9, wherein
said protective element includes any one of a varistor and a zener diode.

12. The display apparatus according to claim 6, wherein
said first terminal of said protective element is connected to at least one internal wiring to which static electricity is discharged easily compared with other internal wirings.

13. The display apparatus according to claim 12, wherein
said internal wiring to which said static electricity is discharged easily is an internal wiring with a large wiring area or an internal wiring connected to an electrode with a large area.

14. The display apparatus according to claim 6, wherein
a plurality of pixels having a switching element, a pixel electrode, and a storage capacitor at least is arranged in said pixel matrix, a COM (common) electrode for impressing a signal voltage common to said each pixel is arranged on said first or said second substrate, and one of said internal wirings connected to said first terminal of said protective element is a COM wiring electrically connected to said COM electrode.

15. The display apparatus according to claim 14, wherein
said COM electrode is formed on said second substrate.

16. The display apparatus according to claim 14, wherein
said COM electrode is formed on said first substrate.

17. The display apparatus according to claim 6, wherein
said protection element is arranged on said first substrate.

18. The display apparatus according to claim 6, further comprising
a connection substrate which is connected to said connection terminal for connecting said display apparatus and said external circuit,
wherein said protective element is arranged on said connection substrate.

19. The display apparatus according to claim 18, wherein
said connection substrate is a flexible substrate.

20. The display apparatus according to claim 14, wherein
two said protective elements is included, said first terminal of each protective element is connected to said COM wiring, and each of said second terminal is connected to each of power source wirings for supplying a different power supply voltage, respectively from an outside for any of said plurality of circuit blocks.

21. The display apparatus according to claim 14, wherein
at least one of said plurality of circuit blocks is a COM electrode drive circuit for driving said COM electrode, and said COM wiring from an output terminal of said COM electrode drive circuit is connected to said COM electrode after being connected to said first terminal of said protective element.

22. The display apparatus according to claim 18, wherein
a first and a second COM wirings are arranged on each of a pair of opposing sides except for a side on which said connection terminal is formed on said first substrate, said first COM wiring and said second COM wiring are connected with a bypass wiring formed on said connection substrate, and said bypass wiring is connected with said first terminal of said protective element.

23. The display apparatus according to claim 6, wherein
said protective element compares a potential of said internal wiring connected to said first terminal, and a predetermined reference voltage, and outputs an abnormal signal according to a difference voltage therebetween.

24. The display apparatus according to claim 23, wherein
said protective element includes a first operational amplifier whose output rises to near a positive polarity side power source voltage when a voltage of said first terminal is larger than said first reference voltage, and becomes near a negative polarity side power source voltage when said voltage thereof is smaller than said first reference voltage, a second operational amplifier whose output becomes near a positive polarity side power source voltage when a voltage of said first terminal is smaller than said second reference voltage, and becomes near a negative electrode positive side power source voltage when said voltage of said first terminal is larger than said second reference voltage, and a logic circuit for outputting an abnormal signal based on results of said first operational amplifier and said second operational amplifier.

25. The display apparatus according to claim 24, wherein
said first reference voltage is a voltage larger to a predetermined quantity than a maximum in a voltage span which is impressed to an internal wiring connected to said first terminal of said protective element, and said second reference voltage is a voltage smaller to a predetermined quantity than a minimum of said voltage span.

26. A display apparatus, comprising:
a substrate;
a pixel matrix which is formed on said substrates and includes a plurality of pixels which include a switching transistor, a storage capacitor, a drive TFT (thin-film-transistor), and an EL (electro-luminescence) diode arranging at each intersection of a data line and a gate line;
a plurality of circuit blocks which performs a predetermined function for driving said pixel matrix;
a connection terminal which connects said display apparatus to an external circuit;
a plurality of internal wirings which connects between said pixel matrix and said each circuit block, and connects mutually said circuit blocks; and
a protective element which includes a first terminal and a second terminal at least;
wherein said first terminal is connected to at least one of said plurality of internal wirings, and said second terminal is connected to said external circuit via said connection terminal.

27. The display apparatus according to claim 26, wherein
said protective element has a nonlinear characteristic that an electrical resistance between said first terminal and said second terminal becomes small when a potential difference therebetween is more than a predetermined value, and said electrical resistance therebetween becomes large when said potential difference is smaller than said predetermined value.

28. The display apparatus according to claim 27, wherein
said protective element includes any one of a varistor and a zener diode.

29. The display apparatus according to claim 26, wherein
said first terminal of said protective element is connected to at least one of power supply lines connected in common to said each EL diode.
